(19) United States
(12) Patent Application Publication
(10) Pub. No.: US 2006/0041400 A1
(43) Pub. Date: Feb. 23, 2006

(54) Measurement and monitoring system of daily stock and plant

(76) Inventors: Ross Richard Nilson, Wellington (NZ); Graeme Alexander Thomson, Wellington (NZ); Campbell Ernest Forrest, Wellington (NZ); Jeremy Bruce Smith, Wellington (NZ)

Correspondence Address: KENYON & KENYON, 1500 K STREET NW, SUITE 700, WASHINGTON, DC, 20005, US

(21) Appl. No.: 10/517,440

(22) PCT Filed: May 26, 2003
(86) PCT No.: PCT/NZ03/00104

§ 371 Date: Jul. 28, 2005

(30) Foreign Application Priority Data
Jun. 10, 2002 (NZ) 519464

(51) Int. Cl. A01J 5/007; A01J 5/01; G01F 1/56; G01N 27/10

(52) U.S. Cl. 702/182; 119/14.14; 324/693; 73/861.08; 702/100

(57) ABSTRACT

A measurement sensor where a mixed solution enters a manifold (1) and is separated in an entry chamber (2) by a whirlpool and/or setting effect. An accumulation chamber (3) and outflow (4) positioned in the lower peripheral of the entry chamber (2) causes the separated solution to preferentially flow to a sensing tube (6) with surface to sectional area dimensions optimised for high frequency electric field measurement of solution parameters used to determine capacitance and conductivity. Overflow of mixed solution enters (5) similar sensing tubes (7), for mixed flow measurements used to determine mass and flow rate. The number and size of the overflow tubes (7) give minimal head loss through the manifold. Solution is recombined in an exit chamber (10) that causes fluid dynamic restrictions (8) to extend solution residence time in measurement tube (6) before exiting the manifold (11). Also disclosed is measurement of a fluid parameter by improving the measurement sensitivity by at least partially canceling the effect of dielectric properties of the containment wall through which the parameter is sensed, and a method for determining plant performance using stored performance profiles.

### FIELD OF INVENTION

This invention relates to in-line measurements for quality control and management of dairy stock and plant.

### BACKGROUND

Approaches in the field can be divided into systems for mastitis detection and systems for volume yield.

Elevated ion levels in the harvested milk are symptomatic of mastitis. Measurement of the resulting increase in conductivity has formed the basis for many mastitis detection systems but practical issues have detracted from useful deployment in a farm context.

A common method to measure conductivity is by positioning electrodes in the solution through the wall of a containing vessel.

A simple implementation of this approach is a hand held conductivity meter. This requires sample collection by the manual stripping of milk directly from the cow. Manual stripping usually is resisted by the cow and becomes a time consuming process poorly suited to high production milking.

Improvements have been proposed by incorporating electrodes directly into the claw of the milking apparatus. This has the potential of facilitating automatic in-line detection with improved reliability using individual quarter conductivity measurements for comparative analysis. Obviously this approach dictates the use of a specialist claw that is generally larger than the traditional arrangement. Both the lack of flexibility in choice of claw and the size are undesirable. In addition, sensor wiring and location on the harsh parlour floor environment and around animal hooves represents practical reliability issues due to incidents of breakage, water damage or wiring failure.

Some conductivity measuring systems have been placed at the top of the long milk tube above the parlour floor. These systems have been targeted at detecting the presence or absence of solution to determine when a cow is finished milking. Accurate measurement for the purposes of mastitis detection has not yet been made practical with this approach.

Approaches with electrodes in solution are subject to electrode fouling or poisoning. This is due to the build up of coatings with poor solubility, preferential plating of metal ions over time or the effect of cleaning agents used in the milking process. The result is calibration drift and measurement inaccuracy that can only be rectified with time consuming regular maintenance or replacement.

To overcome the difficulties associated with electrodes in direct contact with solution, some systems have been proposed with sensing arrangements on the outside of a plastic wall containing the solution. Such arrangements necessarily use high frequency fields since plastic blocks direct or low frequency fields. In proposals to date that use fields of this type, both the effect of the containment wall and the dielectric behaviour of the solution dominate any measurement result and overshadow any small effect due to solution conductivity. As a consequence, while sensing through a plastic containment wall is adequate in detecting the presence or absence of solution, it has not been able to measure conductivity to the accuracy required for mastitis detection in the practical milking situation.

A compounding issue for automatic in-line sensing is the mixed air and solution nature of the flow. The presence of uncertain amounts of air in the solution results in uncertainty in bulk measurements such as conductivity. Systems have been proposed that employ mechanical sampling arrangements that allow for the solution to settle as discrete samples. These systems are complex and often involve moving parts that reduce reliability and increase cost. Many automatic sampling arrangements also require regular cleaning to ensure hygiene levels are maintained.

Approaches for in-line measurement of volume yield also depend on separating solution from air. With most arrangements separated solution is accumulated in a sampling reservoir. One arrangement uses a reservoir that samples a known proportion of solution by splitting a solution jet stream. Yield is determined from total sample volume and the sample is either returned to the bulk solution or discarded. Other proposals involve counting of smaller reservoir samples as they continuously fill and empty. In both cases manual and automatic variations have been suggested.

As with comparable sampling systems for conductivity measurement, arrangements for yield measurement are complex and often involve moving parts that reduce reliability and increase cost. Here again they require regular cleaning to ensure hygiene levels are maintained.

Solutions integrated into management information systems have also been proposed. These systems typically include information in addition to conductivity and yield. They involve databases and provide for the manipulation of management information through computer workstations. The use of databases allows for the tracking of long-term trends that has the potential to improve the reliability of measurements and provide information for comparison overtime or between animals within a particular farm. However, systems of this type are expensive and are necessarily dependent on the underlying sensor technology with the accompanying difficulties described herein.

No cost effective solution suited to automatic performance management within practical tolerances during the normal milking process has been proposed at this time.

### DISCLOSURE OF INVENTION

In an effort to ameliorate the forgoing disadvantages or to at least provide the public with a useful choice, the present invention proposes methods and apparatus of use in monitoring and determining stock and plant performance during the normal milking session.

According to a first aspect of the invention there is provided a method for fluid measurement comprising the steps of:
dividing a fluid or mixed gas and fluid flow between a first and second flow path each path made up of one or more components;
causing the fluid to flow preferentially within the first path having one or more components of relatively high surface to sectional area ratio;
measuring a parameter determined by the fluid in one or more components of the first path having relatively high surface to sectional area ratio; and
determining the conductivity of the fluid within the first path based upon the measured parameter.

According to the second aspect of the invention there is provided a fluid measurement apparatus comprising:
a manifold including a first and second flow path for conveying a fluid or mixed gas and fluid flow, causing the fluid to flow preferentially within one or more components in the first flow path having relatively high surface to sectional area ratio;
a sensor provided for the first path for measuring a parameter determined by the fluid; and
a conductivity determining circuit which represents the conductivity of the fluid based upon the parameter measured by the sensor.

According to the third aspect of the invention there is provided a method for measurement of a parameter of a fluid comprising the steps of:
measuring a parameter determined by a fluid by sensing through a containment wall made of electrically insulating material; and
improving the measurement sensitivity by at least partially cancelling the effect of the dielectric properties of the containment wall.

According to a fourth aspect of the invention there is provided an apparatus for measuring a fluid comprising:
a sensor arrangement for measuring a parameter determined by a fluid through containment walls made of an electrically insulating material;
a signal conditioning circuit that converts the measured parameter into an electrical form; and
a signal conditioning circuit that improves the measurement sensitivity by at least partially cancelling the undesirable effect of the dielectric properties of the containment wall.

According to the fifth aspect of this invention there is provided a method for determining dairy stock and plant performance comprising the steps of:
making performance measurements during a normal milking session;
collecting measurements to incrementally develop performance profiles during a normal milking session;
storing performance profiles as a completed set at the end of a normal milking session;
applying a best fit matching of a stored set to the current milking;
providing settings for user or pre-determined standards of performance; and
providing performance assessment for measurements during the current milking session using assessment criteria that are in part determined by stored profiles.

According to the sixth aspect of this invention there is provided an apparatus for determining dairy stock and plant performance comprising:
a unit for making measurements during a normal milking session;
a unit for collecting and developing measurement profiles, storing completed sets of profiles, matching stored profiles to the current milking and calculating performance criteria to be compared with measurements during the current milking session from standards of performance;
a unit for annunciation of performance during the current milking session; and
a network for communicating information between units.

### BRIEF DESCRIPTION OF THE DRAWINGS

The invention will now be described by example with reference to the accompanying drawings in which:

FIG. 1 shows a schematic diagram of a manifold assembly;

FIG. 2a shows an end view of a manifold assembly;

FIG. 2b shows a side view of a manifold assembly;

FIG. 3 shows a schematic diagram of a sensing system;

FIGS. 4a and 4b show phasor diagrams produced by the circuit of FIG. 3;

FIG. 5 shows a sensor circuit for use in the system of FIG. 3;

FIG. 6 shows a schematic diagram of a signal conditioning circuit; and

FIG. 7 shows an information flow diagram.

### DETAILED DESCRIPTION

The present invention consists of methods and apparatus of use in the monitoring and determination of stock or plant performance during the normal milking process. The methods and apparatus may be used independently or used in combination.

In one embodiment of the present invention the use of the combined methods and apparatus the results in a system that monitors and determines alerts for abnormal stock performance including indicators of milk with mastitis, milk flow, milk volume yield and end of milking. It also monitors and determines alerts for abnormal plant performance including abnormal bail equipment operation and cleaning characteristics. In this embodiment of the present invention, the system comprises a Bail Unit for each milking cluster and a single central Command Unit. A common 2-wire bus for power distribution and communication connects all units.

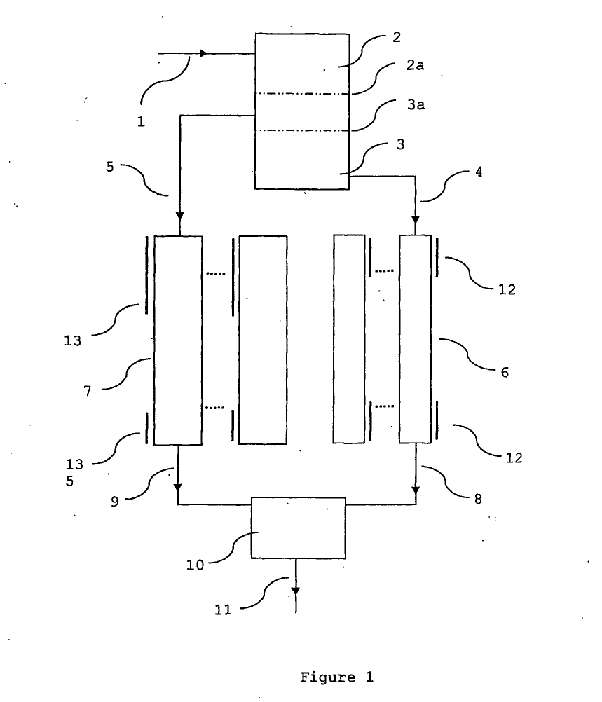

Of relevance to the first and second aspects of the present invention is a manifold that connects in series with the long milking tube from the milking cluster. Solution is transported in the milking tube under differential vacuum and subsequently flows through the manifold as shown in FIG. 1.

Solution enters the manifold through the entry pipe (1) and passes into an entry chamber (2). Air and solution are separated in the entry chamber by a whirlpool and/or settling effect with solution outflow from the outer peripheral of the rotating mass and/or from the bottom of the entry chamber.

From the entry chamber outflow the separated solution passes into an accumulation chamber (3). Chamber walls or baffles are used to improve air solution flow (2a) and define the boundary between the entry and accumulation chambers (3a). Solution is able to build-up in the accumulation chamber and provides short periods of continuous supply to an attached conductivity tube or tubes (6).

The conductivity tube or tubes define the physical arrangement for conductivity sensing. A high length to sectional area ratio and a co-ordinated external electrode configuration (12) is used to enhance solution conductivity effects and reduce solution dielectric effects. This allows for the extraction of a useful conductivity measurement from the otherwise dominating solution capacitance. In one embodiment of the present invention useful performance was achieved with a single plastic tube of about length 120 mm, diameter 9 mm, and wall thickness 0.9 mm and electrodes of about 50 mm length. To ensure the same potential at each end of the tube to prevent erroneous effects from currents in solution external to the tube, one of the electrodes was split into two parts located at each end of the tube and the other electrode was located in the centre of the tube.

The conductivity tube or tubes incorporate a mechanical or fluid dynamic exit restriction (8) to extend solution residence time under conditions of low flow. The size of a mechanical restriction is a compromise between extended residence time and the ability to pass dense or solid components in the solution flow without blockage. In one embodiment of the present invention the exit restriction was achieved by the disturbed fluid dynamic flow where solution the conductivity and bypass tubes re-combine (10).

The conductivity tube or tubes also receive preferential supply from the accumulation chamber to extend performance under low flow conditions. The preferential supply is due to the separation and settling of solution within the entry (2) and accumulation (3) chambers and the lower position of conductivity tube entry orifice (4) compared to entry orifice (5) of the alternative solution passageway through a bi-pass tube or tubes (7).

The bi-pass tube or tubes (7) carry overflow solution from the accumulation chamber mixed with the separated air stream from the entry chamber. The tube dimensions including the entry (5) and exit (9) orifices ensure that the over-all manifold causes minimal head loss.

In a preferred embodiment of the present invention the bi-pass tube or tubes are fitted with electrodes and used to measure fluid mass within the tube. This can be used together with the measurements from the conductivity tubes to determine flow rate and volume yield from the measured mass and mass time dependency, which indicates velocity. Here the tube requires a relatively high surface to sectional area ratio and a co-ordinated external electrode configuration (13) to enhance both dielectric and conductivity effects associated with fluid mass. In one embodiment of the present invention useful performance was achieved with four parallel plastic tubes of about length 120 mm, diameter 12 mm, and wall thickness 0.9 mm and electrode of about 50 mm length. One of the electrodes was split into two parts located at each end of the tube and the other electrode was located in the centre of the tube as for the conductivity tube above.

Solution velocity is obtained from the time dependence of the measured mass. This is most easily illustrated by considering asymmetric electrodes as an example. Fluid often arrives in large “plugs” in sympathy with the pulsation of the milking machine. With an asymmetric electrode, the “plug” first moves past the smaller electrode and then causes a time dependent ramp in mass measurement as it moves past the large electrode. The known electrode length divided by the ramp time gives velocity. Filtering over many “plugs” gives practical results with minimum uncertainty. Other similar methods for obtaining velocity using time dependent mass measurement with symmetrical or split electrodes are equally as effective. In a preferred embodiment of the present device split electrodes were used.

An exit chamber (10) collects the outflow from both the conductivity and bi-pass tube or tubes. The solution exits the manifold through an exit pipe (11)

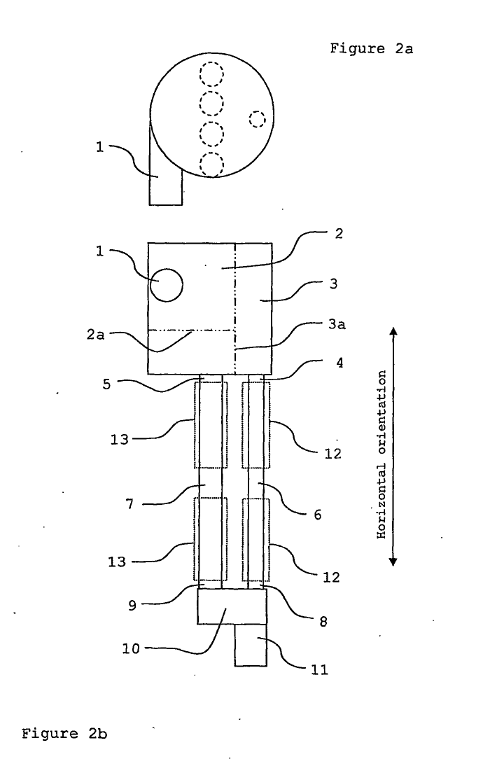

One physical implementation of a manifold arrangement is illustrated in FIGS. 2a and 2b where the entry pipe (1) is tangential to entry chamber (2) to produce the “whirlpool” effect. Like integers have like numbers to those used in FIG. 1.

Of relevance to the third and fourth aspects is conductivity sensing and signal conditioning circuitry that can operate in conjunction with the manifold and attached electrodes described herein or with some other arrangement.

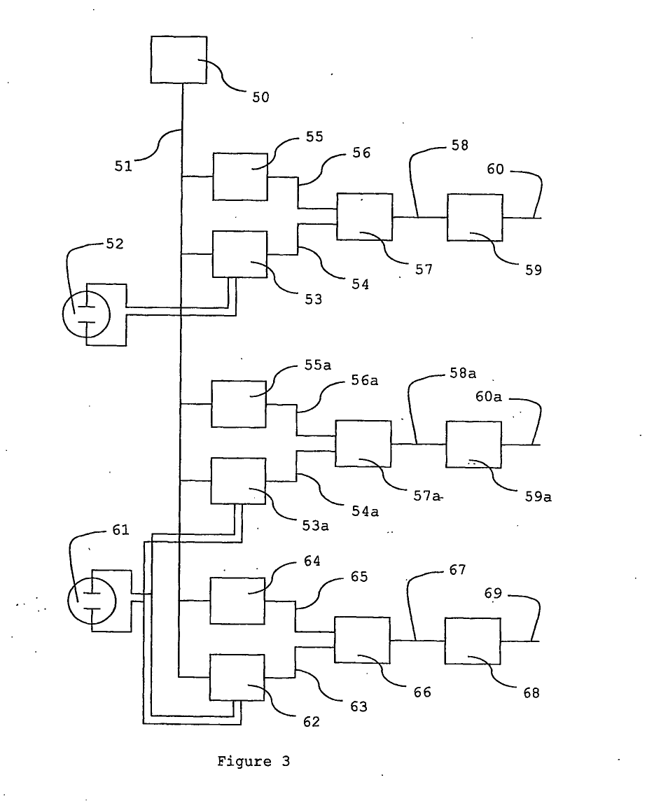

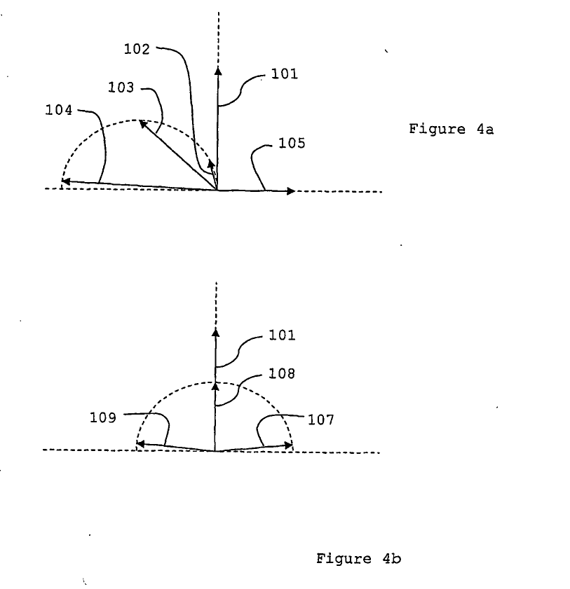

FIGS. 3 and 4 show the signal sensing block diagram and phasor addition method used to improve the conductivity measurement. The sensing system is driven by an oscillator (50) producing a high frequency sine-wave excitation voltage (51). The oscillator frequency is selected for a particular fluid tube and electrode arrangement. In one embodiment of the present invention the manifold described herein a frequency of about 5 MHz was high enough to give a satisfactory performance. The excitation voltage (51) is fed to a conductivity measuring circuit section (53-60) for solution in the conductivity tube or tubes (52). The excitation voltage is also fed to a duplicate conductivity measurement circuit section (53a-60a) and an additional low ion mass measuring circuit (62-69) section for solution in the bi-pass tube or tubes (61). For solutions with high ion concentration a compensated conductivity measurement is used to determine mass whereas for solutions with low ion conductivity the low ion mass measurement is used.

The excitation voltage is impressed across a conductivity sensor assembly (52) by a coupling circuit (53). The sensor assembly represents a load that can be considered as a fixed capacitance due to the tube wall in series with a parallel combination of fixed capacitance due to the solution dielectric and a variable resistance (conductance) due to ion solutes in the solution. However, because of the physical design of the conductivity tube and electrode assembly described herein, the capacitance due to the solution can be neglected and the load, simplified to a fixed capacitance and variable resistance series circuit.

The current in this capacitance-resistance series circuit is shown in the phasor diagram of FIG. 4(a). The reference phasor is the excitation voltage (101). The circuit current leads this voltage with a phase angle that depends on the variable resistance component. At high resistance (low ion concentration) the current is small and has a small phase lead (102). At a standard resistance (typical ion concentration) the current is moderate with a phase lead of about 45 degrees (103). At low resistance (high ion concentration) the current is large and with a phase lead approaching 90 degrees (104). With the ion concentration range found in healthy to mastitis Infected cows the practical variation in phase is rather less than the 0 to 90 degree limit points above. In addition, the current amplitude is small for practical excitation voltage amplitudes and therefore sensitive to interference from electrical noise. The phase of the current does however represent conductivity and is the fundamental output of the sensor (54) (FIG. 3).

In order to improve both the range of phase shift and amplitude of the conductivity sensor, a second development current is employed. This is derived from the excitation voltage (51) using a development current circuit (55). The circuit is designed to produce a current that is equal in magnitude but opposite in phase to the imaginary component of the sensor current output at a standard ion concentration. The development current output (56) and conductivity sensor current output (54) are summed (57) to give the improved performance.

The phasor diagrams in FIGS. 4(a) and (b) illustrate the effect of employing the development current. The development current as designed lags the excitation voltage (101) by −90 degrees (105). When added to the sensor current the resulting output amplitude is maintained a moderate level and the phase shift range is doubled. At high resistance (low ion concentration) the current is moderate with a lag approaching −90 degrees (107). At a standard resistance (typical ion concentration) the current is moderate and about the same phase as the excitation voltage (108). At low resistance (high ion concentration) the current is moderate with a lead approaching 90 degrees (109).

The sensor and development current summer (57) also converts the current to an ac coupled output voltage (58). This is fed to a phase detector circuit (59) to give an unfiltered conductivity measurement output (60).

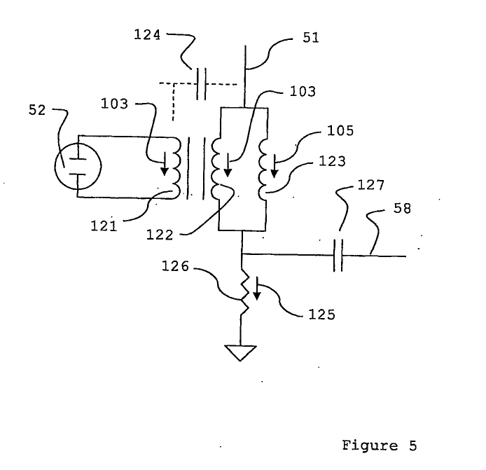

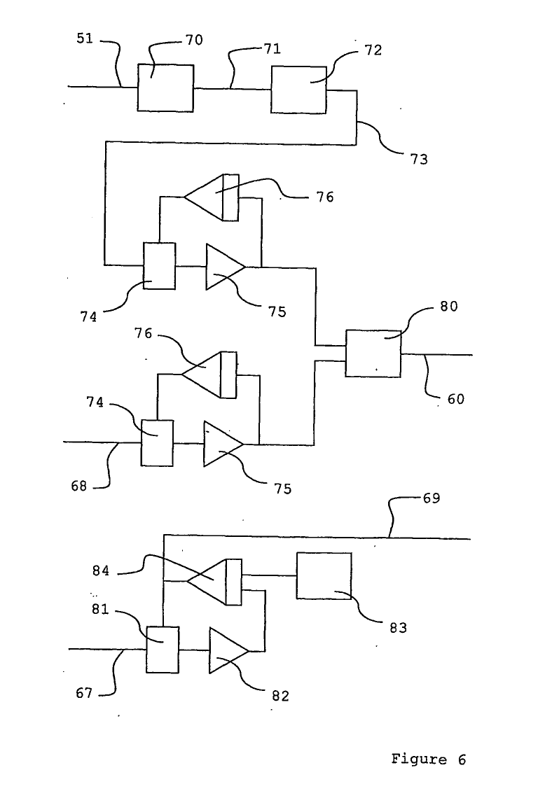

In one embodiment of the present invention the excitation voltage coupling, current phase-shift response, development current summation and ac coupled output are performed by a compact circuit segment shown in FIG. 5. A high frequency transformer (121 to 123) shown in the equivalent circuit form of an ideal transformer (121, 122) and magnetising inductance (23) is used to couple the excitation voltage (51) to the sensor arrangement (52). The sensor response current flows in the transformer secondary (121) and is reflected in the transformer primary (122). The development current flows in the magnetising inductance of the transformer (123). In a real transformer the primary and magnetising inductance are one, and the response and development currents are summed intrinsically. A resistor (126) is used to convert the resulting current (125) to a voltage which is ac coupled using a coupling capacitor (127) to provide the required output voltage (58). The use of a transformer as a coupling device also provides a large common-mode impedance caused only by transformer inter-winding and stray capacitance (124). This reduces spurious behaviour due to stray fields coupling into the sensor fluid and surrounding environment. For one implementation of the sensor arrangement discussed herein the transformer was designed with a magnetising inductance of about 13 uH.

In a preferred embodiment of the present invention the excitation voltage (51) is also impressed across a bi-pass tube or tubes and sensor assembly (61) by a coupling circuit (62). The sensor assembly represents a load that can be considered a capacitor in series with a parallel combination of capacitor and resistor as for the conductivity sensor. With a solution of low ion concentration, the resistance due to the solution is small and the load can be simplified to a fixed capacitance and variable capacitance series circuit.

The current in this capacitance-capacitance series circuit leads the excitation voltage by 90 degrees and has an amplitude that depends on the solution mass within the bi-pass tube. The current has zero amplitude for an empty tube and reaches a maximum when the tube is completely full. The current amplitude when the tube is full is relatively small for practical excitation voltage amplitudes and becomes increasingly sensitive to interference from electrical noise as the tube empties. The current does however represent mass as amplitude and is the fundamental low ion concentration mass sensor output (63) (FIG. 3).

To prevent interference from electrical noise an offset current is used. The offset current is derived from the excitation voltage (51) using an offset current circuit (64). The circuit is designed to produce constant amplitude current in phase with the sensor current output. The offset current (65) and mass sensor current (63) are summed (66) so that an empty bi-pass tube gives a current equal to the offset current.

The mass sensor and offset current summer (66) also converts the current to an ac coupled output voltage (67). This is fed to an amplitude detector circuit (68) to give an unfiltered mass measurement (69). Mass flow, volume and yield are determined from the time dependence of mass within the sensor tube.

In one embodiment of the present invention the excitation voltage coupling, current amplitude response, offset current summation and ac coupled output are performed by the same compact circuit as with the conductivity measurement in FIG. 5.

When the solution has a high ion concentration the situation is similar to that for the conductivity sensor assembly and a duplicate signal conditioning circuit is used to represent mass as phase shift as the unfiltered high ion concentration mass sensor output. Since this operates in identical fashion to the conductivity sensor no further explanation is given here.

The measurement from the conductivity sensor defines the ion concentration of the solution and is used to determine the most appropriate mass sensor output.

In one embodiment of the present invention the phase detector (59) and amplitude detector (68) are as set out in FIG. 5. The approach used gives an accurate and cost effective solution to detecting the phase and amplitude of the high frequency sine-wave signals.

The phase detector compares a zero phase reference output (72) to the improved conductivity output (68). The reference output is used to give a phase reference that tracks the improved conductivity output. The reference output is derived from the excitation voltage (51) using a reference current circuit (70). The output from the reference current circuit (71) is fed to a current to voltage converter with an ac coupled output (72) to give the required zero phase reference (73). In one embodiment of the present invention the zero phase reference output is obtained using a resistance-capacitance phase shift circuit and an ac coupling capacitor.

Subsequent signal conditioning for the zero phase output (72) and the improved conductivity output (68) is through identical pathways to ensure the relative phase relationships are accurately maintained. A precision squaring circuit is formed by the dc restoration circuit (74), high-speed comparator (75) and 50% duty cycle integrator (76). The squaring circuit operates as a feedback regulator for the dc restoration level that produces a square-wave output with a precise 50% duty cycle. Squared-up forms of the two input waveforms (56 and 54) are fed into a high-speed digital phase comparator (80) to give the unfiltered conductivity measurement (60).

The amplitude detector also utilises a precision squaring circuit. This is formed by the dc restoration circuit (81) high-speed comparator (82), duty cycle reference (83), and programmable duty cycle integrator (84). Again the squaring circuit operates as a feedback regulator for the dc restoration level but in this case produces a rectangular-wave output with a duty cycle equal to the duty cycle reference (83) which is set for a low value. When the amplitude of the mass sensor output (67) is small the output of the integrator will produce a dc value slightly less than the switching threshold of the high-speed comparator to maintain a low duty cycle. When the amplitude of the mass sensor output (67) is large the output of the integrator will produce a dc value significantly less than the switching threshold of the high-speed comparator to maintain the same low duty cycle. In this way the dc restoration level represents amplitude and is the unfiltered low ion mass output (69).

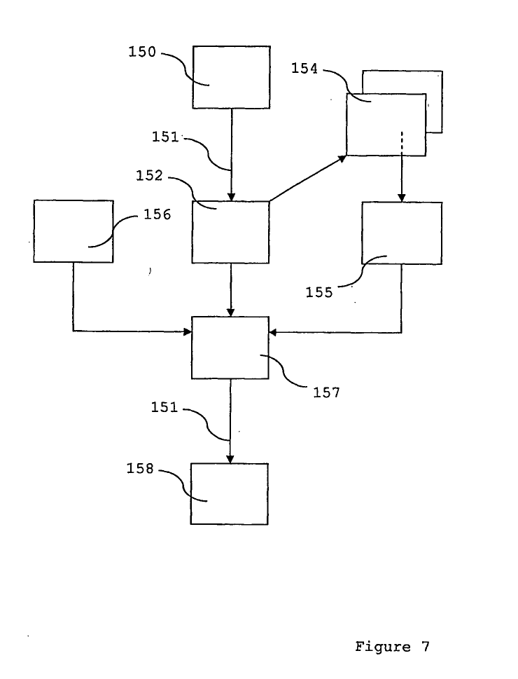

Of relevance to the third and fourth aspects is the use of information in the determination of stock and plant performance during a normal milking session. FIG. 7 shows the information flow.

Multiple measurements are made by multiple units (150) during the milking process. Within each unit the measurements are filtered, combined and qualified by analysing trends as a cow is milked to provide derived parameters with improved reliability or accuracy. The derived parameters are made available over a communications network (152). The information from the communications network is collected and used to incrementally construct statistical profiles for each derived parameter (152) and at the end of the milking process the set of profiles is saved for later use (154). At some stage near the start of the milking process a determination is made as to which of the stored set of profiles best matches the current milking situation (155). The best match set together with user or pre-determined standards of performance (156) and the current incremental profiles (152) are used to calculate performance assessment criteria (157). These are made available on a communications network or used locally. The assessment criteria are used to determine performance by comparison with measurements during the milking (158).

The use of best match profiles allows performance to be monitored and assessed relative to the norms of a particular herd and plant. Performance determined in this way is of the most practical value as farm management is performed within parameters determined by local conditions. It allows performance to track with local variation such as farm location, changes in feed, and stage of lactation. This prevents excessive alerts from absolute measurement not relevant to the local situation. In addition, the selection of best match profiles including frequency of occurrence distributions allows for management with performance standards defined by a number of stock. A standard of this kind can be used with the best match profile distribution to calculate performance criteria for measurements to separate out the desired number of stock. This is in sympathy with on farm management practices and rather more useful than management based on an absolute thresholds.

In one embodiment of the present invention a Bail Unit is used for making measurements (151). The Bail Unit incorporates a microcontroller for signal processing of measurements, operation of local interface outputs and communication over a common power bus.

Signal processing combines conductivity and mass measurements with additional measurements of solution temperature, ambient temperature and time. Processing includes range and mean filtering to remove noise and improve accuracy, linearisation and scaling to give corrected values, and qualification by analysing trends as a cow is milked to provide derived parameters with improved reliability or accuracy. Time and frequency domain analysis are used to determine rates and periodicity. Known heat transfer models can be used to relate temperature information to mixed air and solution to provide an alternative mass-flow estimation.

The information from the low level measurements and derived parameters from signal processing are used to define application level measurements of flow rate, indicative mastitis, volume yield, flow periodicity, flow temperature, cycle time, cycle state (start, mid, end), and cycle type (milking or cleaning).

The application level measurements are compared with calculated performance criteria (157) to determine stock and plant performance. Stock performance includes indicators of milk with mastitis, milk flow, milk volume yield and end of milking. Plant performance includes abnormal bail equipment characteristics including milking time, air solution ratio, pulsator rate. Abnormal cleaning characteristics include correct hot or cold cycles, cleaning phases (rinse, wash) cleaning volume, cleaning temperature and detergent use.

In one embodiment of the present invention performance criteria and measurements are compared in the Bail Unit and indicated through a local interface. One arrangement includes a display with lights (LED's) for performance level and parameter type and an audible sounder and relay output for an unsatisfactory performance alert. Alerts include mastitis (Mastitis alert), low yield (Yield alert), abnormal bail equipment (Plant alert) and abnormal cleaning (Clean alert). Application level parameters are also indicated through the local interface. These include current milk flow, mass, volume, yield and end of milking.

In one embodiment of the present invention the communications network (151) is provided for using modems on a power distribution bus. Connected to the same bus is a Command Unit. In the Command Unit measurements are collected and parameter profiles built (152), sets of profiles stored (152), settings for user and pre-determined standard of performance are provided (158) and performance assessment criteria are calculated.

In one arrangement sets of profiles are stored for two previous milkings (normally the previous morning and evening). The best match profile set is that which corresponds to the current milking based on an elapsed time of about 24 hours. User input is set through a function (parameter type) and threshold (standard of performance) switch stored in the Command Unit with a save switch. Lights (LED's) are used to give an indication of the current settings. Functions can be disabled by special threshold values.

The sensor technology described herein provides for a sufficiently accurate measurement of milk conductivity under the conditions of low flow milk mixed with air to be of practical use in detecting mastitis. It is possible to make accurate conductivity measurements because of the sensor manifold design that provides at least partial separation of milk and air and a conductivity tube geometry with coordinated electrode arrangement for sensing through the tube wall that is sensitive to conductivity. Measurements are further improved by signal conditioning that uses a phasor addition method to cancel unwanted effects caused by sensing through the tube wall. This increases output range and noise immunity. The bi-pass portion of the sensor manifold is used with similar electrode arrangements and sensing circuits enable the solution mass to be measured and therefore mass, flow, volume and yield to be determined. The sensor manifold, electrode arrangement and signal conditioning circuits form a simple, reliable, and low cost sensor with no moving parts, no electrodes in solution, no hygiene traps and minimal head loss.

Placement in the top of the long milking tube provides protection from the harsh milking environment and enables automatic measurements. Preferred arrangements include additional sensing and signal processing that provides for additional measurements of stock and plant performance.

Implementation using multiple Bail Units communicating over a network to a single Command Unit allows for profiles of measurement parameters to be constructed and stored.

This enables standards of performance to be defined in terms of on farm stock and plant norms using levels or number of stock in contrast to other systems that enforce absolute standards. Using standards within an on farm context is in keeping with farm management as is actually practised.

The Bail Unit and Command Unit implementation provides an effective low cost solution well suited to the practical farm environment. The basic system can be extended for other dairy automation requirements including remote display, cow identification and counting, automatic cluster removal, supplement feeding and automatic cow drafting.

A preferred communications interface on the Command Unit together with support software enables remote access using standard telecommunications infrastructures including the internet to provide farm or industry based computer systems and services.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope or spirit of the present invention.

1. A method of fluid measurement comprising the steps of:
dividing a fluid or mixed gas and fluid flow between a first and second flow path each made up of one or more components;
causing the fluid to flow preferentially within the first path having one or more components of a relatively high surface to sectional area ratio;
measuring a parameter determined by the fluid in one or more components of the first path having a relatively high surface to sectional area ratio; and
determining the conductivity of the fluid based upon the measured parameter.

2. The method according to claim 1 wherein gas is at least partly separated from fluid to aid the preferential flow of fluid to the first flow path.

3. The method according to claim 1 wherein gas is at least partly separated from fluid to aid the preferential flow of fluid to the first flow path by the introduction of a swirling action.

4. The method according to claim 1 wherein gas is at least partly separated from fluid to aid the preferential flow of fluid to the first flow path by use of a surge or settling chamber type action.

5. The method according to claim 1 wherein fluid to the first flow path is accumulated to sustain a more continuous flow.

6. The method according to claim 1 wherein fluid flow from the first flow path is restricted to increase residence time or time for continuous flow.

7. The method according to claim 1 wherein fluid volume in the first flow path is minimised to increase residence time or time for continuous flow.

8. The method according to claim 1 wherein one or more components of the first flow path is fitted with sensors for measuring parameters determined by the fluid.

9. The method according to claim 1 wherein one or more components of the first flow path is fitted with sensors for measuring parameters determined by the fluid used to directly or indirectly represent the conductivity of the fluid.

10. The method according to claim 1 wherein one or more components in the second flow path is used to bi-pass fluid or gas and fluid mix not able to be accommodated by the first flow path.

11. The method according to claim 10 wherein one or more components in the second flow path is used to bi-pass fluid or gas and fluid mix not able to be accommodated by the first flow path with dimensions that minimise pressure or vacuum head loss.

12. The method according to claim 1 wherein one or more components in the second flow path is used to bi-pass fluid or gas and fluid mix not able to be accommodated by the first flow path is fitted with sensors to measure a parameter determined by the fluid or gas and fluid mix.

13. The method according to any claim 1 wherein a measurement is made of a parameter determined by the fluid in one or more components of the second flow path having a relatively high surface to sectional area ratio;

14. The method according to claim 1 wherein the measured parameter in one or more components in the second flow path is used to directly or indirectly determine fluid mass and thereby flow rate and volume.

15. A fluid measurement apparatus comprising:
a manifold including a first and second flow path for conveying a fluid or mixed gas and fluid flow, causing the fluid to flow preferentially within one or more components in the first flow path having relatively high surface to sectional area ratio;
a sensor provided for the first path for measuring a parameter determined by the fluid; and
a conductivity determining circuit which represents the conductivity of the fluid based upon the parameter measured by the sensor.

16. The apparatus according to claim 15 using a manifold that employs a method of fluid measurement comprising the steps of:
dividing a fluid or mixed gas and fluid flow between a first and second flow path each made up of one or more components;
causing the fluid to flow preferentially within the first path having one or more components of a relatively high surface to sectional area ratio;
measuring a parameter determined by the fluid in one or more components of the first path having a relatively high surface to sectional area ratio; and
determining the conductivity of the fluid based upon the measured parameter.

17. The apparatus according to claim 15 wherein a sensor constructed from electrodes distributed along the length of one or more components in the first path and at least partly surrounding the fluid either on the inside or outside of any containment walls is used.

18. The apparatus according to claim 15 wherein high frequency electric fields are coupled to the sensor electrodes.

19. The apparatus according to claim 15 wherein current or voltage phase or amplitude response is used directly or indirectly to represent conductivity and/or mass and thereby flow rate and volume.

20. A method for measurement of a parameter of a fluid comprising the steps of:
measuring a parameter determined by a fluid by sensing through a containment wall made of electrically insulating material; and
improving the measurement sensitivity by at least partially canceling the effect of the dielectric properties of the containment wall.

21. The method according to claim 20 wherein the parameter to be measured is influenced by solutes or solvents that give rise to conductive properties.

22. The method according to claim 20 where the fluid concerned is constrained to a form with relatively high surface to sectional area ratio within a containment wall made of electrically insulating material.

23. The method according to claim 20 wherein a sensor is constructed from electrodes distributed along the length of the constrained form at least partly surrounding the fluid outside the containment walls.

24. The method according to claim 20 wherein a high frequency voltage waveform is coupled to the sensor electrodes.

25. The method according to wherein a current phase or amplitude response is used to determine a measurement.

26. The method according to claim 20 wherein the phasor addition of another signal cancels out at least part of the response due to the capacitance effect from the containment wall dielectric.

27. The method according to claim 20 wherein a phase detector or amplitude detector is used to produce an output used to directly or indirectly represent conductivity and/or mass and thereby flow rate and volume.

28. The method according to claim 24 wherein voltage is used in place of current and current is used in place of voltage,

29. The method according to claim 20 wherein the measurement of the parameter of the fluid is used to directly or indirectly represent conductivity and/or mass and thereby flow rate and volume;

30. The method according to claim 20 wherein the measurement of the parameter of the fluid is manipulated with algorithms to filter and/or combine with other measurements and/or qualify by analysing time trends to improved reliability or accuracy of the measurement itself or what it is used to directly or indirectly represent.

31. An apparatus for measuring a fluid comprising:
a sensor arrangement for measuring a parameter determined by a fluid through containment walls made of an electrically insulating material;
a signal conditioning circuit that converts the measured parameter into an electrical form; and
a signal conditioning circuit that improves the measurement sensitivity by at least partially cancelling the undesirable effect of the dielectric properties of the containment wall.

32. The apparatus according to claim 31 using a method for measurement of a parameter of a fluid comprising the steps of:
measuring a parameter determined by a fluid by sensing through a containment wall made of electrically insulating material; and
improving the measurement sensitivity by at least partially cancelling the effect of the dielectric properties of the containment wall.

33. The apparatus according to claim 31 wherein an electrode coupling device with high common mode impedance is used in order to reduce effects of stray capacitance to the fluid and surrounding environment.

34. The apparatus according to claim 31 wherein functions are realized within single components.

35. The apparatus according to claim 31 wherein phase or amplitude detection involves converting current or voltage waveforms into square or rectangular waveforms with certain timing relationships.

36. The apparatus according to claim 35 wherein conversion to square or rectangular waveforms involves a comparator with a feedback loop acting on the duty cycle of the comparator output to adjust the comparator input.

37. The apparatus according to claim 31 wherein a signal conditioning circuit provides and output used to directly or indirectly represent conductivity and/or mass and thereby flow rate and volume.

38. The apparatus according to claim 31 wherein outputs from a signal conditioning circuit determine measurements that are acted on by an algorithm to filter and/or combine with other measurements and/or qualify by analysing time trends to improved reliability or accuracy of the measurement itself or what it is used to directly or indirectly represent.

39. A method for determining dairy stock and plant performance comprising the steps of:
making performance measurements during a normal milking session,
collecting measurements to incrementally develop performance profiles during a normal milking session;
storing performance profiles as a completed set at the end of a normal milking session;
applying a best fit matching of a stored set to the current milking;
providing settings for user or pre-determined standards of performance; and
providing performance assessment for measurements during the current milking session using assessment criteria that are in part determined by stored profiles.

40. The method according to claim 39 wherein measurements are made automatically during the milking session.

41. The method according to claim 39 wherein measurements are made for individual cows with or without retaining individual cow identification information.

42. The method according to claim 39 wherein measurements are made or derived that represent stock performance including milk flow rate, volume, mass, yield and conductivity.

43. The method according to claim 39 wherein measurements are made or derived that represent plant milking performance including pulsing action, milking time, and air or fluid flow rates or ratios.

44. The method according to claim 39 wherein measurements are made or derived that represent plant cleaning performance including hot and cold cycles, fluid volume, time and detergent use.

45. The method according to claim 39 wherein performance profiles include distributions, averages, maximums, minimums for individual cows or parts or all of a herd.

46. The method according to claim 39 wherein stored performance characteristics for stock can be representative of standards defining a number of cows or a level within the herd.

47. The method according to claim 39 wherein stored characteristics are matched on the basis of the last diurnal milking period corresponding to the current milking.

48. The method according to claim 39 wherein performance during the current milking can be categorised as satisfactory or unsatisfactory or represented as a relative value.

49. The method according to claim 39 wherein measurements result in local annunciation.

50. The method according to claim 39 wherein measurements are used to determine end of milking or cluster removal for individual cows.

51. The method according to claim 39 wherein individual cow identification system is incorporated.

52. The method according to claim 39 wherein remote access is incorporated including access to a farm computer system, industry computer system or the internet.

53. An apparatus for determining dairy stock and plant performance comprising:
a unit for making measurements during a normal milking session;
a unit for collecting and developing measurement profiles, storing completed sets of profiles, matching stored profiles to the current milking and calculating performance criteria to be compared with measurements during the current milking session from standards of performance;
a unit for annunciation of performance during the current milking session; and
a network for communicating information between units.

54. The apparatus according to claim 53 using a method for determining dairy stock and plant performance comprising the steps of:
making performance measurements during a normal milking session,
collecting measurements to incrementally develop performance profiles during a normal milking session;
storing performance profiles as a completed set at the end of a normal milking session;
applying a best fit matching of a stored set to the current milking;
providing settings for user or pre-determined standards of performance; and
providing performance assessment for measurements during the current milking session using assessment criteria that are in part determined by stored profiles.

55. The apparatus according to claim 53 wherein measurements are made with a unit at each milking cluster.

56. The apparatus according to claim 53 wherein measurements are made at each milking cluster in-line with the long milk hose from the milking cluster or the equivalent.

57. The apparatus according to claim 53 wherein a commercial computer with appropriate adaptations and software or dedicated device with inbuilt computing capability is used for the unit collecting and developing measurements to define and store performance profiles and determining performance standards for the current milking session.

58. The apparatus according to claim 53 wherein the unit for annunciation is also used to input user selected standards or to announce performance for the current milking session.

59. The apparatus according to claim 53 wherein some or all of the units perform their functions automatically.

60. The apparatus according to claim 53 wherein announcement of performance for the current milking session is made with a unit at the milking cluster position as part of the measuring unit or a separate unit.

61. The apparatus according to claim 53 wherein communication between units is performed using a standard telecommunication network system or a dedicated network including a power line modem.
